(19) United States
(12) Patent Application Publication
(10) Pub. No.: US 2026/0167800 A1
(43) Pub. Date: Jun. 18, 2026

(54) UNSATURATED FATTY OIL OR UNSATURATED FATTY OIL DERIVATIVE MODIFIED SUBSTITUTED PHENOL RESINS, AND METHODS OF MAKING AND USING THEREOF

(71) Applicant: Neville Chemical Company, Pittsburgh, PA (US)

(72) Inventors: Liwei Yu, Pittsburgh, PA (US); Steven C. Kratz, Pittsburgh, PA (US); Isabella A. Weinland, Pittsburgh, PA (US); Nicholas P. Morris, Pittsburgh, PA (US); Maxwell A. Allman, Pittsburgh, PA (US); John T. Ruffner, Pittsburgh, PA (US); Timothy E. Calabrese, Pittsburgh, PA (US)

(21) Appl. No.: 18/983,613

(22) Filed: Dec. 17, 2024

(51) Int. Cl. C08K 11/00; C08F 12/12

(52) U.S. Cl. CPC C08K 11/00; C08F 12/12

(57) ABSTRACT

Embodiments relate to resin compositions including 5-95 wt % of at least one unsaturated fatty oil or derivatives thereof, 5-95 wt % of a mixture of at least one vinyl hydrocarbon substituted phenol and at least one short polymer of vinyl monomers, and 0-50 wt % of at least one unsaturated fatty oil (or unsaturated fatty oil derivative) substituted phenol, and methods of making and using thereof. The resin compositions may offer lower viscosity compared to their petroleum derived phenol-based counterparts and may demonstrate excellent compatibility with a broad range of solvents, epoxy curing agents and liquid epoxy resins. As unsaturated fatty oil (or unsaturated fatty oil derivative) content can range from 5-95 wt % of the total resin, dependency on fossil fuels and carbon emissions may be significantly reduced while maintaining or enhancing the technical performance of epoxy systems.

### FIELD

Embodiments generally relate to resin compositions including bio-based materials and petroleum-derived components, particularly to unsaturated fatty oil (or unsaturated fatty oil derivative) modified substituted phenol resin compositions.

### BACKGROUND

Phenol-modified hydrocarbon resins are extensively utilized in coatings, adhesives, and rubber compound formulations. These resins enhance and significantly improve the performance of these applications. The versatility of these resins is derived from their complex composition, which results from the reaction between phenols and vinyl aliphatic or aromatic monomers. The resulting materials typically contain a mixture of monomeric and polymeric components with distinct chemical functionalities.

The process for manufacturing phenol-modified hydrocarbon resins involves catalyzing the reaction of phenols with vinyl hydrocarbon monomers, such as styrene, alpha-methyl styrene, vinyl toluene, and indene, using acid catalyst. This reaction produces a range of resins, from liquid to solid, and the properties of these resins can be tailored through careful adjustments to the reaction conditions, with the most crucial factor being the selection of structural variations in both the phenol and the vinyl hydrocarbon monomer building blocks. By mixing different phenols and vinyl monomers, manufacturers can achieve the desired balance of polarity, solubility, and fluidity. This balance is intimately related to the hydroxyl functionality, the content of aromatic and hydrophobic moieties, and the polymer fraction, including molecular weight distribution.

Despite the benefits of traditional petroleum-based phenol-modified hydrocarbon resins, their production is resource-intensive and has significant environmental impacts, contributing to greenhouse gas emissions and pollution. A commonly used additive in traditional epoxy resin systems is nonyl phenol, a petroleum-derived compound frequently used as a curing accelerator and plasticizer. However, nonyl phenol faces increasing regulatory scrutiny due to its classification as an endocrine-disrupting chemical (EDC), persistent environmental presence, and adverse effects on wildlife and human health. The European Union has classified it as a Substance of Very High Concern (SVHC) under its REACH regulations, leading to restrictions and bans in various applications.

As global demand for sustainable and non-toxic materials rises, industries are actively seeking alternatives to hazardous petroleum-based chemicals like nonyl phenol. The development of bio-based resins from renewable resources presents a promising solution, although these materials often involve performance trade-offs, including slower curing times, reduced mechanical strength, or incompatibility with existing systems. Thus, striking a balance between sustainability, regulatory compliance, and performance remains a critical challenge.

### SUMMARY

Embodiments described herein address the above-described challenges and offer a resin composition that integrates bio-based materials with petroleum-derived components, thereby leveraging the strengths of both features to create an unsaturated fatty oil (or unsaturated fatty oil derivative) modified substituted phenol resin that is both sustainable and high-performing. By adjusting the ratio of unsaturated fatty oil or its derivatives to petroleum-based components, embodiments allow for the fine-tuning of properties to suit specific applications while contributing to a reduced environmental impact and ensuring regulatory compliance by eliminating the need for hazardous substances such as nonyl phenol.

In particular embodiments relate to resin compositions derived from unsaturated fatty oil or its derivatives, vinyl hydrocarbon monomers, and phenols, as well as methods of making and using thereof. These resins offer lower viscosity compared to their petroleum derived phenol-based counterparts and demonstrate excellent compatibility with a broad range of solvents, epoxy curing agents, and liquid epoxy resins. The unsaturated fatty oil (or unsaturated fatty oil derivative) content can range from 5% to 95% of the total resin, significantly reducing dependency on fossil fuels and lower carbon emissions while maintaining or enhancing the technical performance of epoxy systems. By adjusting the ratio of unsaturated fatty oil or its derivatives to petroleum-based components, the resin composition allows for customized performance, including accelerated curing, extended pot life, enhanced adhesion, increased flexibility and impact resistance, and superior chemical resistance. This versatility makes described embodiments ideal as non-reactive diluents for epoxy coating or adhesive systems.

In an exemplary embodiment, a resin composition comprises between about 5 and about 95 wt % of at least one unsaturated fatty oil or derivatives thereof; between about 5 and about 95 wt % of a mixture of at least one vinyl hydrocarbon substituted phenol and at least one short polymer of vinyl hydrocarbon monomers; and between about 0 and about 50 wt % of at least one compound selected from the group consisting of an unsaturated fatty oil substituted phenol and derivatives thereof.

In some embodiments, the resin composition comprises between about 5 and about 15 wt % of at least one unsaturated fatty oil or derivatives thereof; between about 85 and about 95 wt % of a mixture of at least one vinyl hydrocarbon substituted phenol and at least one short polymer of vinyl hydrocarbon monomers; and between about 0 and about 10 wt % of at least one compound selected from the group consisting of an unsaturated fatty oil substituted phenol and derivatives thereof.

In some embodiments, the resin composition comprises between about 60 and about 95 wt % of at least one unsaturated fatty oil or derivatives thereof; between about 5 and about 40 wt % of a mixture of at least one vinyl hydrocarbon substituted phenol and at least one short polymer of vinyl hydrocarbon monomers; and between about 30 and about 50 wt % of at least one compound selected from the group consisting of an unsaturated fatty oil substituted phenol and derivatives thereof.

In some embodiments, the resin composition comprises between about 20 and about 40 wt % of at least one unsaturated fatty oil or derivatives thereof; between about 60 and about 80 wt % of a mixture of at least one vinyl hydrocarbon substituted phenol and at least one short polymer of vinyl hydrocarbon monomers; and between about 10 and about 20 wt % of at least one compound selected from the group consisting of an unsaturated fatty oil substituted phenol and derivatives thereof.

In some embodiments, the at least one unsaturated fatty oil is selected from the group consisting of vegetable oil, fish oil, and mixtures thereof.

In some embodiments, the vegetable oil is selected from the group consisting of sunflower oil, safflower oil, rapeseed oil, olive oil, peanut oil, walnut oil, corn oil, and mixtures thereof.

In some embodiments, the at least one vinyl hydrocarbon substituted phenol comprises a phenolic compound selected from the group consisting of phenol, cresol, nonyl phenol, 4-Cumylphenol, benzylphenol, p-octyl phenol, resorcinol, hydroquinone, pyrocatechol, pyrogallol, dihydroxydiphenyl, alpha-naph thol, beta-naphthol, cardanol, and mixtures thereof.

In some embodiments, the phenolic compound is further selected from the group consisting of a monosubstituted phenolic compound, a disubstituted phenolic compound, a trisubstituted phenolic compound, and mixtures thereof.

In some embodiments, the at least one vinyl hydrocarbon substituted phenol comprises a vinyl hydrocarbon selected from the group consisting of styrene, alpha-methylstyrene, vinyltoluene, indene, alpha-vinylnaphthalene, diisopropenylbenzene, the C9 fraction from a petroleum cracking process, divinylbenzene, mixtures of divinylbenzene and ethylvinylbenzenes, and mixtures thereof.

In some embodiments, the at least one short polymer of vinyl hydrocarbon monomers comprises vinyl hydrocarbon monomers selected from the group consisting of styrene, alpha-methylstyrene, vinyltoluene, indene, alpha-vinylnaphthalene, diisopropenylbenzene, the C9 fraction from a petroleum cracking process, divinylbenzene, mixtures of divinylbenzene and ethylvinylbenzenes, and mixtures thereof.

In some embodiments, the at least one short polymer of vinyl hydrocarbon monomers comprises cyclic dimers and trimers of the vinyl hydrocarbon monomers.

In an exemplary embodiment, a method for synthesizing the resin composition comprises reacting a phenol with at least one compound selected from the group consisting of a vinyl hydrocarbon, an unsaturated fatty oil or derivatives thereof, and mixtures thereof, in the presence of an organic solvent and an acid catalyst.

In some embodiments, the acid catalyst comprises an acid selected from the group consisting of strong inorganic and Lewis acid, organic sulfonic acid, solid state/supported acid, and mixtures thereof.

In some embodiments, the strong inorganic and Lewis acid is selected from the group consisting of sulfuric acid, hydrofluoric acid, hexafluorophosphoric acid, tetrafluoroboric acid, perchloric acid, boron trifluoride, boron trichloride (and their complexes), zinc chloride, aluminum chloride, titanium chloride, zirconium chloride, aluminum phenoxide, and mixtures thereof.

In some embodiments, the acid catalyst is present in an amount between about 0.01 and about 1.00 wt % based on the total weight of the reactants.

In some embodiments, the solid state/supported acid is selected from the group consisting of Nafion resin, sulfonated poly(styrene-co-divinylbenzene) resin, sulfuric acid doped silica, acid-activated montmorillonite, zeolite, acid-activated bentonite clay, and mixtures thereof.

In some embodiments, the acid catalyst is present in an amount between about 0.05 and about 5.00 wt % based on the total weight of the reactants.

In some embodiments, reacting the phenol with the at least one compound is carried out at a temperature ranging from −10° C. to 150° C.

In some embodiments, reacting the phenol with the at least one compound is carried out at a temperature ranging from 40° C. to 120° C.

### BRIEF DESCRIPTION OF THE DRAWINGS

FIG. 1 is an exemplary reaction mechanism for one embodiment of the disclosure.

FIG. 2 is an exemplary reaction mechanism for one embodiment of the disclosure.

### DETAILED DESCRIPTION

The following description is of exemplary embodiments of unsaturated fatty oil (or unsaturated fatty oil derivative) modified substituted phenol resins, and methods of making and using said resins. This description is not to be taken in a limiting sense but is made merely for the purpose of describing the general principles and features of various aspects of the present invention. The scope of the present invention is not limited by this description.

Unless defined otherwise, all technical and scientific terms used herein have the same meaning as commonly understood by one of ordinary skill in the art to which the subject matter disclosed herein belongs. Although any methods, devices, and materials similar or equivalent to those described herein can be used in the practice or testing of the presently disclosed subject matter, representative methods, devices, and materials are described herein.

All references to singular characteristics or limitations of the present disclosure shall include the corresponding plural characteristic(s) or limitation(s) and vice versa, unless otherwise specified or clearly implied to the contrary by the context in which the reference is made.

As used herein (when used in this application, including the claims), the terms “a,” “an,” and “the” refer to “one or more.” The use of the word “a” or “an” when used in conjunction with the term “comprising” in the claims and/or the specification may mean “one,” but it is also consistent with the meaning of “one or more,” “at least one,” and “one or more than one.”

All combinations of method or process steps as used herein can be performed in any order, unless otherwise specified or clearly implied to the contrary by the context in which the referenced combination is made.

The methods and devices of the present disclosure, including components thereof, can comprise, consist of, or consist essentially of the essential elements and limitations of the embodiments described herein, as well as any additional or optional components or limitations described herein or otherwise useful.

As used herein, the term “about” means±2% of the recited value. As used herein, ranges can be expressed as from “about” one particular value, and/or to “about” another particular value. It is understood that there are a number of values disclosed herein, and that each value is also herein disclosed as “about” that particular value in addition to the value itself. For example, if the value “5” is disclosed, then “about 5” is also disclosed. It is also understood that each unit between two particular units are also disclosed. For example, if 5 and 10 are disclosed, then 6, 7, 8, and 9 are also disclosed.

As used herein, “alkyl” includes branched, straight chain and cyclic, substituted or unsubstituted saturated aliphatic hydrocarbon groups. Alkyl groups can comprise about 1 to about 24 carbon atoms (“C1-C24”), about 7 to about 24 carbon atoms (“C7-C24”), about 8 to about 24 carbon atoms (“C8-C24”), or about 9 to about 24 carbon atoms (“C9-C24”). Alkyl groups can also comprise about 1 to about 8 carbon atoms (“C1-C8”), about 1 to about 6 carbon atoms (“C1-C6”), or about 1 to about 3 carbon atoms (“C1-C3”). Examples of C1-C6 alkyl groups include, but are not limited to, methyl, ethyl, propyl, isopropyl, butyl, sec-butyl, tert-butyl, pentyl, isopentyl, neopentyl, hexyl, isohexyl, cyclohexyl, cyclohexylmethyl, cyclopropylmethyl and neohexyl.

As used herein, “phenol” is an aromatic organic compound with the molecular formula C₆H₅OH.

As used herein, “substituted phenol” is a phenol in which at least one hydrogen atom has been replaced with another atom or group.

As used herein, “unsaturated fatty oil” is an oil with one or more double bonds between carbon atoms in its fatty acid chains.

As used herein, a “derivative” of a compound refers to a species having a chemical structure that is similar to the compound, yet containing a chemical group not present in the compound and/or deficient of a chemical group that is present in the compound.

As used herein, “vinyl hydrocarbon” is an organic compound containing a vinyl group (e.g., CHCH₂; two carbon atoms connected by a double bond, with one of the carbon atoms also bonded to two hydrogen atoms).

As used herein, the term “short polymer” refers to a polymer that consists of greater than 2 repeating monomer units, such as between 2 and 200 repeating monomer units.

Embodiments relate to resin compositions including (a) at least one unsaturated fatty oil or derivatives thereof, (b) a mixture of at least one vinyl hydrocarbon substituted phenol and at least one short polymer of vinyl monomers, and optionally (c) at least one unsaturated fatty oil (or unsaturated fatty oil derivative) substituted phenol.

Unsaturated fatty oil(s) or derivative(s) thereof can be present in the resin composition in any suitable amount, and may be present from about 5% to about 95% by weight of the composition. In some embodiments, unsaturated fatty oil(s) or derivative(s) thereof may be present from about 5% to about 15%, preferably from about 5% to about 10%, by weight of the composition. Such embodiments may be particularly advantageous to achieve accelerated curing speed of the composition. In other embodiments, unsaturated fatty oil(s) or derivative(s) thereof may be present from about 60% to about 95%, preferably from about 70% to about 90%, by weight of the composition. Such embodiments may be particularly advantageous to achieve an extended pot life and/or to enhance flexibility of the composition. In still other embodiments, unsaturated fatty oil(s) or derivative(s) thereof may be present from about 20% to about 40%, preferably from about 25% to about 35%, by weight of the composition. Such embodiments may be particularly advantageous to balance overall performance characteristics of the composition.

In some embodiments, unsaturated fatty oil(s) may be selected from the group consisting of vegetable oil, fish oil, and mixtures thereof. In some embodiments, a vegetable oil may be selected from the group consisting of sunflower oil, safflower oil, rapeseed oil, olive oil, peanut oil, walnut oil, corn oil, and mixtures thereof.

In some embodiments, unsaturated fatty oil derivative(s) may be selected from the group consisting of fatty acid, fatty acid alkyl ester, and mixtures thereof.

A mixture of vinyl hydrocarbon substituted phenol(s) and short polymers of vinyl hydrocarbon monomer(s) can be present in the resin composition in any suitable amount. The mixture may be present from about 5% to about 95% by weight of the composition. In some embodiments, the mixture may be present from about 85% to about 95%, preferably from about 90% to about 95%, by weight of the composition. Such embodiments may be particularly advantageous to achieve accelerated curing speed of the composition. In other embodiments, the mixture may be present from about 5% to about 40%, preferably from about 10% to about 30%, by weight of the composition. Such embodiments may be particularly advantageous to achieve an extended pot life and/or to enhance flexibility of the composition. In still other embodiments, the mixture may be present from about 60% to about 80%, preferably from about 65% to about 75%, by weight of the composition. Such embodiments may be particularly advantageous to balance overall performance characteristics of the composition.

Vinyl hydrocarbon substituted phenol(s) include a phenol in which at least one of its hydrogen atoms is replaced with a vinyl hydrocarbon. In some embodiments, phenol(s) may be selected from the group consisting of phenol, cresol, nonyl phenol, 4-Cumylphenol, benzylphenol, p-octyl phenol, resorcinol, hydroquinone, pyrocatechol, pyrogallol, dihydroxydiphenyl, alpha-naph thol, beta-naphthol, cardanol, and mixtures thereof. In some embodiments, substituted phenol(s) may include at least one of monosubstituted, disubstituted, and trisubstituted phenolic compounds, and mixtures thereof.

In some embodiments, vinyl hydrocarbon(s) may be a compound of Formula (I).

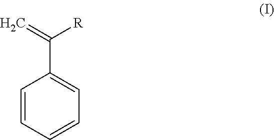

wherein R is selected from the group consisting of H and an alkyl group.

In some embodiments, vinyl hydrocarbon(s) may be selected from the group consisting of styrene, alpha-methylstyrene, vinyltoluene, indene, alpha-vinylnaphthalene, diisopropenylbenzene, the C9 fraction from a petroleum cracking process, divinylbenzene, mixtures of divinylbenzene and ethylvinylbenzenes, and mixtures thereof.

Short polymers of vinyl hydrocarbon monomers may include greater than 2, or between 2 and 200, repeating vinyl hydrocarbon monomer units. Vinyl hydrocarbon units may be selected from the group consisting of styrene, alpha-methylstyrene, vinyltoluene, indene, alpha-vinylnaphthalene, diisopropenylbenzene, the C9 fraction from a petroleum cracking process, divinylbenzene, mixtures of divinylbenzene and ethylvinylbenzenes, and mixtures thereof.

In some embodiments, short polymers may include cyclic dimers and trimers of the vinyl monomers, and linear oligomers.

Unsaturated fatty oil substituted phenol(s), or unsaturated fatty oil derivative substituted phenol(s), include a phenol in which at least one of its hydrogen atoms are replaced with an unsaturated fatty acid or a derivative thereof, and can be present in a resin composition in any suitable amount. Unsaturated fatty oil substituted phenol(s), or unsaturated fatty oil derivative substituted phenol(s), may be present from about 0% (or greater than 0%) to about 50% by weight of the composition. In some embodiments, unsaturated fatty oil substituted phenol(s), or unsaturated fatty oil derivative substituted phenol(s), may be present from about 0% (or greater than 0%) to about 10%, preferably from about 0% (or greater than 0%) to about 5%, by weight of the composition. Such embodiments may be particularly advantageous to achieve accelerated curing speed of the composition. In other embodiments, unsaturated fatty oil substituted phenol(s), or unsaturated fatty oil derivative substituted phenol(s), may be present from about 30% to about 50%, preferably from about 35% to about 45%, by weight of the composition. Such embodiments may be particularly advantageous to achieve an extended pot life and/or to enhance flexibility of the composition. In still other embodiments, unsaturated fatty oil substituted phenol(s), or unsaturated fatty oil derivative substituted phenol(s), may be present from about 10% to about 20%, preferably from about 10% to about 15%, by weight of the composition. Such embodiments may be particularly advantageous to balance overall performance characteristics of the composition.

In some embodiments, phenol(s) may be selected from the group consisting of phenol, cresol, nonyl phenol, 4-Cumylphenol, benzylphenol, p-octyl phenol, resorcinol, hydroquinone, pyrocatechol, pyrogallol, dihydroxydiphenyl, alpha-naph thol, beta-naphthol, cardanol, and mixtures thereof.

In some embodiments, substituted phenol(s) may include at least one of monosubstituted, disubstituted, and trisubstituted phenolic compounds, and mixtures thereof.

In some embodiments, unsaturated fatty oil(s) may be selected from the group consisting of vegetable oil, fish oil, and mixtures thereof. In some embodiments, a vegetable oil may be selected from the group consisting of sunflower oil, safflower oil, rapeseed oil, olive oil, peanut oil, walnut oil, corn oil, and mixtures thereof.

In some embodiments, unsaturated fatty oil derivative(s) may be selected from the group consisting of fatty acid, fatty acid alkyl ester, and mixtures thereof.

Embodiments further relate to methods of making a resin composition described above. At least one fatty oil substituted phenol, or unsaturated fatty oil derivative substituted phenol, may be synthesized by reacting a phenol with unsaturated fatty oil or a derivative thereof, in the presence of an organic solvent and an acid catalyst. The substitution reaction may be carried out at a temperature ranging from −10° C. to 150° C., preferably from 40° to 120° C. When the substitution reaction is over, the organic solvent may be removed by any suitable process, such as distillation.

At least one vinyl hydrocarbon substituted phenol may similarly be synthesized by reacting a phenol with vinyl hydrocarbon(s), in the presence of an organic solvent and an acid catalyst. The substitution reaction may be carried out at a temperature ranging from −10° C. to 150° C., preferably from 40° to 120° C. When the substitution reaction is over, the organic solvent may be removed by any suitable process, such as distillation.

In some embodiments, at least one unsaturated fatty oil substituted phenol, or unsaturated fatty oil derivative substituted phenol, and at least one vinyl hydrocarbon substituted phenol may be synthesized together. For example, a phenol may be reacted with an unsaturated fatty oil or a derivative thereof and a vinyl hydrocarbon, in the presence of an organic solvent and an acid catalyst. The substitution reactions may be carried out at a temperature ranging from −10° C. to 150° C., preferably from 40° to 120° C. When the substitution reactions are over, the organic solvent may be removed by any suitable process, such as distillation.

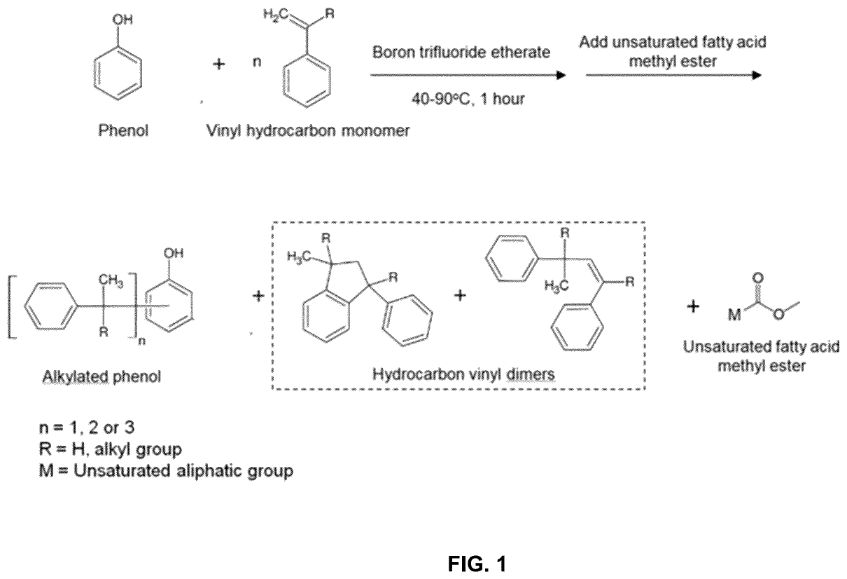

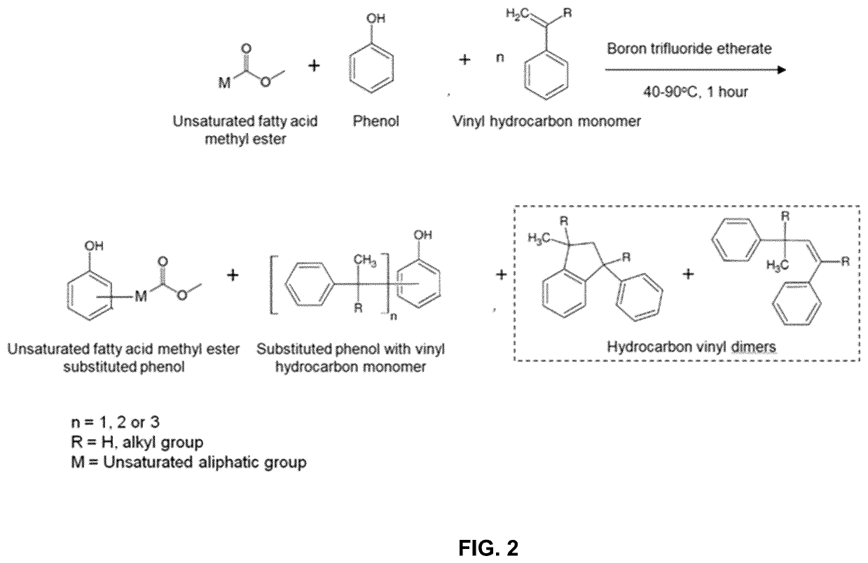

FIG. 1 illustrates generally the reaction mechanism of substitution reaction of phenol with vinyl hydrocarbon monomer and then modified with unsaturated fatty acid methyl ester. FIG. 2 illustrates generally the reaction mechanism of substitution reaction of phenol with vinyl hydrocarbon monomer and unsaturated fatty acid methyl ester.

The acid catalyst may include an acid selected from the group consisting of strong inorganic and Lewis acid, organic sulfonic acid, solid state/supported acid, and mixtures thereof. The type and the amount of acid catalyst may be selected based on desired catalytic activity. For strong inorganic and Lewis acids, the catalyst concentration may be about 0.01 to about 1.00 wt %, preferably about 0.05 to 0.2 wt %, based on the total weight of the reactants. For organic sulfonic acids, the catalyst concentration may be about 0.05 to about 5.0 wt %, preferably about 0.3 to 1.0 wt %, based on the total weight of the reactants.

In some embodiments, a strong inorganic and Lewis acid may be selected from the group consisting of sulfuric acid, hydrofluoric acid, hexafluorophosphoric acid, tetrafluoroboric acid, perchloric acid, boron trifluoride, boron trichloride (and their complexes), zinc chloride, aluminum chloride, titanium chloride, zirconium chloride, aluminum phenoxide, and mixtures thereof.

In some embodiments, a solid state/supported acid may be selected from the group consisting of Nafion resins, sulfonated poly(styrene-co-divinylbenzene) resins, sulfuric acid doped silica, acid-activated montmorillonite, zeolites, acid-activated bentonite clays, and mixtures thereof.

### EXAMPLES

The following examples provide exemplary embodiments of the present invention, and the examples are not intended to limit the scope of the invention in any way.

TABLE 1
Chemical name and trade name list

| Chemical | | |
|---|---|---|
| Name | Chemistry | Supplier |
| Soy methyl | — | FENO |
| ester | | |
| Soybean oil | — | Cargill |
| Styrene | — | Sigmaaldrich |
| Phenol | — | Sigmaaldrich |
| Boron trifluoride | — | Sigmaaldrich |
| diethyl etherate | | |
| Xylene | — | Sigmaaldrich |
| Epicure 3125 | Medium viscosity reactive polyamide | Hexion |
| | curing agent | |
| Ancomine K54 | tris-(dimethylaminomethyl) phenol | Evonik |
| Epon 828 | Bisphenol-A type liquid epoxy resin | Hexion |
| Epon 1001-x-75 | Bisphenol-A type liquid epoxy resin | Hexion |
| Cymel U-21-511 | Partially n-butylated urea resin | Allnex |
| Nonyl phenol | — | Sigmaaldrich |
| Novares LS 500 | Styrenated phenol | Rain Carbon |
| Novares LA | Alpha-methyl styrenated phenol | Rain Carbon |
| 1900 | | |
| Novares LA 100 | Alpha-methyl styrenated phenol | Rain Carbon |
| AEP | Aminoethylpiperazine | Sigmaaldrich |
| DACH | 1,2-Diaminocyclohexane | Sigmaaldrich |
| IPDA | Isophorone diamine | Sigmaaldrich |

TABLE 2
Resin Properties

| | Resin | Resin | Resin | Resin | Resin | Resin | Resin |
|---|---|---|---|---|---|---|---|
| Properties | 1 | 2 | 3 | 4 | 5 | 6 | 7 |
| Gardner | 3 | 4 | 1 | 1 | 7 | 6 | 1 |
| Color | | | | | | | |
| Viscosity, | 500 | 100 | 10 | 1100 | 110 | 30 | 1600 |
| cPs | | | | | | | |
| Unsaturated | 10 | 30 | 80 | 10 | 30 | 70 | 10 |
| fatty oil (or | | | | | | | |
| unsaturated | | | | | | | |
| fatty oil | | | | | | | |
| derivative)% | | | | | | | |
| Compatibility | Clear | Clear | Clear | Clear | Clear | Clear | Clear |
| with Epicure | | | | | | | |
| 3125 | | | | | | | |
| Compatibility | Clear | Clear | Clear | Clear | Clear | Clear | Clear |
| with Epon | | | | | | | |
| 828 | | | | | | | |

| | Nonyl | Novares | Novares | Novares |
|---|---|---|---|---|
| Properties | Phenol | LS 500 | LA 1900 | LA 100 |
| Gardner | 1 | 3 | 1.5 | 1.5 |
| Color | | | | |
| Viscosity, | 1200 | 800 | 2300 | 100 |
| cPs | | | | |
| Unsaturated | 0 | 0 | 0 | 0 |
| fatty oil (or | | | | |
| unsaturated | | | | |
| fatty oil | | | | |
| derivative)% | | | | |
| Compatibility | Clear | Clear | Clear | Clear |
| with Epicure | | | | |
| 3125 | | | | |
| Compatibility | Clear | Clear | Clear | Clear |
| with Epon | | | | |
| 828 | | | | |

### Example 1: Liquid Resin Preparation

To synthesize liquid Resin 1, 16 g of xylene and 33 g of phenol were first pumped into a reactor. The mixture was warmed to 60° C., at which point 0.5 g of boron trifluoride diethyl etherate was added. The temperature was then raised to 80° C., and 50 g of styrene was gradually introduced. The reaction proceeded for 1 hour at 80° C. Afterward, lime was added to neutralize the mixture, followed by filtration to remove the lime. The xylene was then removed via vacuum distillation. Finally, 6 g of soy methyl ester was added to the solution, and the mixture was cooled to yield the liquid Resin 1, which had the following properties (listed in Table 2): Brookfield Viscosity (25° C., spindle #21)=500 cPs; Gardner color=3.

### Example 2: Liquid Resin Preparation

To synthesize liquid Resin 2, 16 g of xylene and 33 g of phenol were first pumped into a reactor. The mixture was warmed to 60° C., at which point 0.5 g of boron trifluoride diethyl etherate was added. The temperature was then raised to 80° C., and 50 g of styrene was gradually introduced. The reaction proceeded for 1 hour at 80° C. Afterward, lime was added to neutralize the mixture, followed by filtration to remove the lime. The xylene was then removed via vacuum distillation. Finally, 35 g of soy methyl ester was added to the solution, and the mixture was cooled to yield the liquid Resin 2, which had the following properties (listed in Table 2): Brookfield Viscosity (25° C., spindle #21)=100 cPs; Gardner color=4.

### Example 3: Liquid Resin Preparation

To synthesize liquid Resin 3, 16 g of xylene and 33 g of phenol were first pumped into a reactor. The mixture was warmed to 60° C., at which point 0.5 g of boron trifluoride diethyl etherate was added. The temperature was then raised to 80° C., and 50 g of styrene was gradually introduced. The reaction proceeded for 1 hour at 80° C. Afterward, lime was added to neutralize the mixture, followed by filtration to remove the lime. The xylene was then removed via vacuum distillation. Finally, 320 g of soy methyl ester was added to the solution, and the mixture was cooled to yield the liquid Resin 3, which had the following properties (listed in Table 2): Brookfield Viscosity (25° C., spindle #21)=10 cPs; Gardner color=1.

### Example 4: Liquid Resin Preparation

To synthesize liquid Resin 4, 16 g of xylene and 30 g of phenol were first pumped into a reactor. The mixture was warmed to 60° C., at which point 0.5 g of boron trifluoride diethyl etherate was added. The temperature was then raised to 80° C., 48 g of styrene and 6 g of soy methyl ester was gradually introduced. The reaction proceeded for 1 hour at 80° C. Afterward, lime was added to neutralize the mixture, followed by filtration to remove the lime. The xylene was then removed via vacuum distillation to get the liquid Resin 4, which had the following properties (listed in Table 2): Brookfield Viscosity (25° C., spindle #21)=1100 cPs; Gardner color=1.

### Example 5: Liquid Resin Preparation

To synthesize liquid Resin 5, 16 g of xylene and 18 g of phenol were first pumped into a reactor. The mixture was warmed to 60° C., at which point 0.5 g of boron trifluoride diethyl etherate was added. The temperature was then raised to 80° C., 40 g of styrene and 25 g of soy methyl ester was gradually introduced. The reaction proceeded for 1 hour at 80° C. Afterward, lime was added to neutralize the mixture, followed by filtration to remove the lime. The xylene was then removed via vacuum distillation to get the liquid Resin 5, which had the following properties (listed in Table 2): Brookfield Viscosity (25° C., spindle #21)=110 cPs; Gardner color=7.

### Example 6: Liquid Resin Preparation

To synthesize liquid Resin 6, 16 g of xylene and 45 g of phenol were first pumped into a reactor. The mixture was warmed to 60° C., at which point 0.5 g of boron trifluoride diethyl etherate was added. The temperature was then raised to 80° C., and 35 g of soy methyl ester was gradually introduced. The reaction proceeded for 1 hour at 80° C. Afterward, lime was added to neutralize the mixture, followed by filtration to remove the lime. The xylene was then removed via vacuum distillation to get the liquid Resin 6, which had the following properties (listed in Table 2): Brookfield Viscosity (25° C., spindle #21)=30 cPs; Gardner color=3.

### Example 7: Liquid Resin Preparation

To synthesize liquid Resin 7, 16 g of xylene and 30 g of phenol were first pumped into a reactor. The mixture was warmed to 60° C., at which point 0.5 g of boron trifluoride diethyl etherate was added. The temperature was then raised to 80° C., 48 g of styrene and 6 g of soybean oil was gradually introduced. The reaction proceeds for 1 hour at 80° C. Afterward, lime was added to neutralize the mixture, followed by filtration to remove the lime. The xylene was then removed via vacuum distillation to get the liquid Resin 7, which had the following properties (listed in Table 2): Brookfield Viscosity (25° C., spindle #21)=1600 cPs; Gardner color=1.

### Example 8: Application

Nonyl phenol has been widely used in epoxy coatings, but due to regulatory concerns, the industry has begun phasing it out from formulations. Commercial phenol-hydrocarbon resins have been commonly used as replacements. However, in two-component epoxy formulations, when these resins are mixed with amine curing agents, the resulting mixture's viscosity does not match that of the nonyl phenol/amine mixture, especially at higher resin-to-amine ratios, which significantly limits their usage.

Tables 3, 4, and 5 compare the viscosities of the inventive resins, commercial phenol-hydrocarbon resin, and nonyl phenol after mixing with various amines at different ratios. It is observed that using Resins 1, 4, and 7 as diluents led to a greater reduction in the viscosity of liquid epoxy compared to the commercial phenol-hydrocarbon resin, and resulted in a viscosity similar to that of nonyl phenol when mixed with amines.

TABLE 3
Viscosity Stability with AEP

| Liquid | | | | | | |
|---|---|---|---|---|---|---|
| resin:AEP | | | | | | |
| weight ratio | 100:0 | 90:10 | 80:20 | 75:25 | 50:50 | 25:75 |
| Resin 1 | 480 | 16,230 | 11,520 | 4,635 | 177.5 | 40 |
| Resin 4 | 1,122 | 4,005 | 2,200 | 1,240 | 52 | 37.5 |
| Resin 7 | 1,582 | 57,500 | 17,650 | 9,075 | 225 | 65 |
| Novares LS | 1,342 | 161,000 | 104,000 | 26,330 | 285 | 47.5 |
| 500 | | | | | | |
| Nonyl phenol | 1,236 | 13,120 | 11,120 | 6,138 | 207.5 | 52.5 |

TABLE 4
Viscosity Stability with DACH

| Liquid resin: DACH | | |
|---|---|---|
| weight ratio | 75:25 | 25:75 |
| Resin 1 | 930 | 15 |
| Resin 4 | 1,840 | 22.5 |
| Resin 7 | 2,332 | 22.5 |
| Novares LS 500 | 3,283 | 28 |
| Nonyl phenol | 1,970 | 18 |

TABLE 5
Viscosity Stability with IPDA

| Liquid resin: IPDA | | |
|---|---|---|
| weight ratio | 75:25 | 25:75 |
| Resin 1 | 23,000 | 58 |
| Resin 4 | 37,700 | 60 |
| Resin 7 | 13,500 | 92.5 |
| Novares LS 500 | 203,000 | 85 |
| Nonyl phenol | 37,300 | 78 |

TABLE 6
Epoxy Coating Part A and B Formula

| | Wt % |
|---|---|
| Part A | |
| Epicure 3125 | 92.1 |
| Ancomine K54 | 7.9 |
| Total | 100.0 |
| Part B | |
| Epon 828 | 41.1 |
| Epon 1001-x-75 | 54.7 |
| Cymel U-21-511 | 4.2 |
| Total | 100.0 |

TABLE 7
Liquid Resin Modified Epoxy Coating Formula

| | | 5% Liquid | 20% liquid |
|---|---|---|---|
| Epoxy Coating | | Resin | Resin |
| Formula | Control | modification | modification |
| Part A | 23.7 | 22.5 | 19.0 |
| Part B | 76.3 | 72.5 | 61.0 |
| Liquid resin | | 5.0 | 20.0 |
| Total | 100.0 | 100.0 | 100.0 |

To better compare the coating performance between the invented resins and commercial resins, we developed a screening 2K epoxy coating formula, as shown in Table 6. Since the diluents are non-reactive, we maintained the same ratio of epoxy Part A to Part B, and modified the formula by adding 5% and 20% of the diluents. The resulting coating formulas are listed in Table 7.

Table 8 presents the coating performance test results for the non-modified (control) formula and formulas modified with nonyl phenol, Resin 1, and Resin 4. Compared to the control, the formula modified with resin showed a shorter gel time, especially with a 20% modification, indicating the curing acceleration effect brought by nonyl phenol, Resin 1, and Resin 4. The modified formula also showed comparable dry time, adhesion, film hardness, and MEK resistance, with improved flexibility and impact resistance.

In comparison with nonyl phenol, Resin 1 and Resin 4 exhibited similar gel time, comparable dry time, adhesion, film hardness, chemical resistance, and flexibility, along with a significant improvement in impact resistance, likely due to the plasticizing effect of the soy methyl ester. These results suggest that Resin 1 and Resin 4 could serve as an effective offset for nonyl phenol in epoxy systems.

TABLE 8
Epoxy Coating Performance Test

| Epoxy | Test | | 5% liquid resin | | | 20% liquid resin | | |
|---|---|---|---|---|---|---|---|---|
| coating | Method | Control | modification | | | modification | | |
| Properties | | N/A | Nonyl | Resin 1 | Resin 4 | Nonyl | Resin 1 | Resin 4 |
| | | | Phenol | | | Phenol | | |
| Gel time, | ASTM | 91 | 71 | 72 | 65 | 46 | 52 | 54 |
| min | D3532 | | | | | | | |
| Dry time | ASTM | 0.5 | 1 | 0.75 | 0.6 | 1 | 1 | 1.5 |
| (Tack free), | D5895 | | | | | | | |
| hr | | | | | | | | |
| Dry time | ASTM | 3 | 3.4 | 3.3 | 3.3 | 3 | 4 | 3.6 |
| (Dry | D5895 | | | | | | | |
| through), hr | | | | | | | | |
| Cross Hatch | ASTM | 5B | 5B | 5B | 5B | 5B | 5B | 5B |
| Adhesion | D3359 | | | | | | | |
| Pencil | ASTM | H | H | H | H | H | H | H |
| Hardness | D3363 | | | | | | | |
| MEK | ASTM | Pass | Pass | Pass | Pass | Pass | Pass | Pass |
| Chemical | D4752 | | | | | | | |
| Resistance | | | | | | | | |
| (100 double | | | | | | | | |
| rubs) | | | | | | | | |
| Mandrel | ASTM | Fail | Fail | Pass | Pass | Pass | Pass | Pass |
| Bend | D522 | | | | | | | |
| Impact | ASTM | 40 | 68 | 66 | 66 | 40 | 48 | 82 |
| Resistance | D2794 | | | | | | | |
| (in-lbs) | | | | | | | | |

### Example 9: Application

Table 9 presents the coating performance comparison between the invented resins and a commercial phenol-hydrocarbon resin, which is based on alpha-methyl styrenated phenol. Compared to the control (non-modified), the modified formulas showed comparable gel time, extended dry time, comparable adhesion, film hardness, and chemical resistance, along with improved flexibility and impact resistance.

When comparing the commercial resin with Resin 2 and Resin 5, the invented resins exhibited slightly longer gel time but faster dry time, while showing similar adhesion, film hardness, chemical resistance, flexibility, and impact resistance. We believe that the soy methyl ester substituted phenol or modified styrenated phenol achieved a similar effect to that of alpha-methyl styrenated phenol.

TABLE 9
Epoxy Coating Performance Test

| Epoxy | Test | | 5% liquid resin | | | 20% liquid resin | | |
|---|---|---|---|---|---|---|---|---|
| coating | Method | Control | modification | | | modification | | |
| Properties | | N/A | Novares | Resin 2 | Resin 5 | Novares | Resin 2 | Resin 5 |
| | | | LA 1900 | | | LA 1900 | | |
| Gel time, | ASTM | 91 | 83 | 86 | 88 | 80 | 90 | 93 |
| min | D3532 | | | | | | | |
| Dry time | ASTM | 0.5 | 1.5 | 1.5 | 1.3 | 2 | 2.5 | 1.5 |
| (Tack free), | D5895 | | | | | | | |
| hr | | | | | | | | |
| Dry time | ASTM | 3 | 4.3 | 4.2 | 3.8 | 5 | 4.9 | 4 |
| (Dry | D5895 | | | | | | | |
| through), hr | | | | | | | | |
| Cross Hatch | ASTM | 5B | 5B | 5B | 5B | 5B | 5B | 5B |
| Adhesion | D3359 | | | | | | | |
| Pencil | ASTM | H | H | H | H | H | H | H |
| Hardness | D3363 | | | | | | | |
| MEK | ASTM | Pass | Pass | Pass | Pass | Pass | Pass | Pass |
| Chemical | D4752 | | | | | | | |
| Resistance | | | | | | | | |
| (100 double | | | | | | | | |
| rubs) | | | | | | | | |
| Mandrel | ASTM | Fail | Pass | Pass | Pass | Pass | Pass | Pass |
| Bend | D522 | | | | | | | |
| Impact | ASTM | 40 | 85 | 80 | 70 | 77 | 76 | 75 |
| Resistance | D2794 | | | | | | | |
| (in-lbs) | | | | | | | | |

### Example 10: Application

We further compared the invented resins (with increased unsaturated fatty oil or derivative content) with another commercial phenol-hydrocarbon resin based on alpha-methyl styrenated phenol. Table 10 presents their performance in epoxy coatings. Since the commercial phenol-hydrocarbon resin is primarily used to extend pot life, we only evaluated a 5% modification in this application.

Compared to the control, the modified formula showed extended gel time, indicating an extended pot life, with no significant impact on dry time, adhesion, film hardness, or chemical resistance. However, we observed improvements in flexibility and impact resistance.

When compared to the commercial resin, Resin 3 and Resin 6 demonstrated greater efficiency in extending gel time. Resin 3 showed very similar performance to the commercial resin, while Resin 6 had slightly weaker flexibility and impact resistance compared to the other two resins.

TABLE 10
Epoxy Coating Performance Test

| Epoxy | | | 5% liquid resin modification | | |
|---|---|---|---|---|---|
| coating | Test | Control | Novares | | |
| Properties | Method | N/A | LA 100 | Resin 3 | Resin 6 |
| Gel time, min | ASTM | 91 | 95 | 107 | 105 |
| | D3532 | | | | |
| Dry time (Tack | ASTM | 0.5 | 1.3 | 1 | 1 |
| free), hr | D5895 | | | | |
| Dry time (Dry | ASTM | 3 | 3.1 | 3 | 3 |
| through), hr | D5895 | | | | |
| Cross Hatch | ASTM | 5B | 5B | 5B | 5B |
| Adhesion | D3359 | | | | |
| Pencil | ASTM | H | H | H | H |
| Hardness | D3363 | | | | |
| MEK Chemical | ASTM | Pass | Pass | Pass | Pass |
| Resistance | D4752 | | | | |
| (100 double | | | | | |
| rubs) | | | | | |
| Mandrel Bend | ASTM | Fail | Pass | Pass | Fail |
| | D522 | | | | |
| Impact | ASTM | 40 | 80 | 85 | 50 |
| Resistance | D2794 | | | | |
| (in-lbs) | | | | | |

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A resin composition, comprising:
between about 5 and about 95 wt % of at least one unsaturated fatty oil or derivatives thereof;
between about 5 and about 95 wt % of a mixture of at least one vinyl hydrocarbon substituted phenol and at least one short polymer of vinyl hydrocarbon monomers; and
between about 0 and about 50 wt % of at least one compound selected from the group consisting of an unsaturated fatty oil substituted phenol and derivatives thereof.

2. The resin composition of claim 1, comprising:
between about 5 and about 15 wt % of at least one unsaturated fatty oil or derivatives thereof;
between about 85 and about 95 wt % of a mixture of at least one vinyl hydrocarbon substituted phenol and at least one short polymer of vinyl hydrocarbon monomers; and
between about 0 and about 10 wt % of at least one compound selected from the group consisting of an unsaturated fatty oil substituted phenol and derivatives thereof.

3. The resin composition of claim 1, comprising:
between about 60 and about 95 wt % of at least one unsaturated fatty oil or derivatives thereof;
between about 5 and about 40 wt % of a mixture of at least one vinyl hydrocarbon substituted phenol and at least one short polymer of vinyl hydrocarbon monomers; and
between about 30 and about 50 wt % of at least one compound selected from the group consisting of an unsaturated fatty oil substituted phenol and derivatives thereof.

4. The resin composition of claim 1, comprising:
between about 20 and about 40 wt % of at least one unsaturated fatty oil or derivatives thereof;
between about 60 and about 80 wt % of a mixture of at least one vinyl hydrocarbon substituted phenol and at least one short polymer of vinyl hydrocarbon monomers; and
between about 10 and about 20 wt % of at least one compound selected from the group consisting of an unsaturated fatty oil substituted phenol and derivatives thereof.

5. The resin composition of claim 1, wherein the at least one unsaturated fatty oil is selected from the group consisting of vegetable oil, fish oil, and mixtures thereof.

6. The resin composition of claim 5, wherein the vegetable oil is selected from the group consisting of sunflower oil, safflower oil, rapeseed oil, olive oil, peanut oil, walnut oil, corn oil, and mixtures thereof.

7. The resin composition of claim 1, wherein the at least one vinyl hydrocarbon substituted phenol comprises a phenolic compound selected from the group consisting of phenol, cresol, nonyl phenol, 4-Cumylphenol, benzylphenol, p-octyl phenol, resorcinol, hydroquinone, pyrocatechol, pyrogallol, dihydroxydiphenyl, alpha-naph thol, beta-naphthol, cardanol, and mixtures thereof.

8. The resin composition of claim 7, wherein the phenolic compound is further selected from the group consisting of a monosubstituted phenolic compound, a disubstituted phenolic compound, a trisubstituted phenolic compound, and mixtures thereof.

9. The resin composition of claim 1, wherein the at least one vinyl hydrocarbon substituted phenol comprises a vinyl hydrocarbon selected from the group consisting of styrene, alpha-methylstyrene, vinyltoluene, indene, alpha-vinylnaphthalene, diisopropenylbenzene, the C9 fraction from a petroleum cracking process, divinylbenzene, mixtures of divinylbenzene and ethylvinylbenzenes, and mixtures thereof.

10. The resin composition of claim 1, wherein the at least one short polymer of vinyl hydrocarbon monomers comprises vinyl hydrocarbon monomers selected from the group consisting of styrene, alpha-methylstyrene, vinyltoluene, indene, alpha-vinylnaphthalene, diisopropenylbenzene, the C9 fraction from a petroleum cracking process, divinylbenzene, mixtures of divinylbenzene and ethylvinylbenzenes, and mixtures thereof.

11. The resin composition of claim 1, wherein the at least one short polymer of vinyl hydrocarbon monomers comprises cyclic dimers and trimers of the vinyl hydrocarbon monomers.

12. A method for synthesizing the resin composition of claim 1, comprising:
reacting a phenol with at least one compound selected from the group consisting of a vinyl hydrocarbon, an unsaturated fatty oil or derivatives thereof, and mixtures thereof, in the presence of an organic solvent and an acid catalyst.

13. The method of claim 12, wherein the acid catalyst comprises an acid selected from the group consisting of strong inorganic and Lewis acid, organic sulfonic acid, solid state/supported acid, and mixtures thereof.

14. The method of claim 13, wherein the strong inorganic and Lewis acid is selected from the group consisting of sulfuric acid, hydrofluoric acid, hexafluorophosphoric acid, tetrafluoroboric acid, perchloric acid, boron trifluoride, boron trichloride (and their complexes), zinc chloride, aluminum chloride, titanium chloride, zirconium chloride, aluminum phenoxide, and mixtures thereof.

15. The method of claim 14, wherein the acid catalyst is present in an amount between about 0.01 and about 1.00 wt % based on the total weight of the reactants.

16. The method of claim 13, wherein the solid state/supported acid is selected from the group consisting of Nafion resin, sulfonated poly(styrene-co-divinylbenzene) resin, sulfuric acid doped silica, acid-activated montmorillonite, zeolite, acid-activated bentonite clay, and mixtures thereof.

17. The method of claim 16, wherein the acid catalyst is present in an amount between about 0.05 and about 5.00 wt % based on the total weight of the reactants.

18. The method of claim 12, wherein reacting the phenol with the at least one compound is carried out at a temperature ranging from −10° C. to 150° C.

19. The method of claim 12, wherein reacting the phenol with the at least one compound is carried out at a temperature ranging from 40° C. to 120° C.
